(19) United States
(12) Patent Application Publication
(10) Pub. No.: US 2010/0036113 A1
(43) Pub. Date: Feb. 11, 2010

(54) PROCESS FOR TREATING CELLULOSE PULP USING CARBOXYMETHYCELULOSE AND PULP THUS OBTAINED

(76) Inventors: Otavio Mambrim Filho, Aracruz (BR); Rosaria Luisa Mainieri, Porto Alegre (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/514,196

(22) PCT Filed: Mar. 26, 2007
(86) PCT No.: PCT/BR2007/000075

§ 371 Date: Oct. 8, 2009

(30) Foreign Application Priority Data
Nov. 9, 2006 (BR) PI0605651-2

(51) Int. Cl. C08B 1/00

(52) U.S. Cl. 536/56

(57) ABSTRACT

The present invention relates to an improved process for processing chemical cellulose pulp wherein carboxymethylcellulose (CMC) is added during the bleaching step of said pulp. The addition of CMC in this step of the bleaching process provides a pulp with improved physical, chemical and mechanical properties.

### FIELD OF THE INVENTION

The present invention relates to a process for improving the mechanical strength property of bleached cellulose fiber pulps employing carboxymethylcellulose as an additive in the acid stage of the bleaching sequence.

### BACKGROUND OF THE INVENTION

The use of carboxymethylcellulose (CMC) in the cellulose industry has been extensively studied in recent years. The addition of CMC may provide improved properties to the pulp, such as higher tensile strength, if added under proper conditions or combined with other products.

This compound, when used, is normally added to the already finished pulp, that is, after being submitted to the cooking and bleaching processes, before the paper manufacturing process proper. In other words and in the conventional jargon of the paper industry, carboxymethylcellulose as well as other additives used in cellulose pulps is added to the already cooked and bleached pulp, before being sent to the paper production “machine.”

Document BR 0107989-1, for instance, discloses the use of chemical additives adsorbable in cellulose pulp. Although the text of said document refers to “pulp processing,” the specification and examples clearly state that the process of the invention relates to the use of said additives in pulp ready for paper manufacturing, and there is no reference to the addition of these adsorbable additives during the bleaching process per se. It is desirable to obtain CMC adsorption on the cellulose fibers during the treatment process of the fiber pulp before the processing thereof in the paper machines. If this adsorption provides the same or better quality results of the pulp than the ones obtained when CMC is added to the paper production machine, this represents a huge advantage for the cellulose manufacturer, increasing the product's value added.

Some prior-art documents disclose the use of CMC in the pulp bleaching and/or cooking stages, but in restricted and specific conditions and for several purposes. Document U.S. Pat. No. 3,956,165 discloses a pulp bleaching process comprising the addition of an acrylic acid polymer to the bleaching solution, wherein the results may be improved with the joint addition of CMC. In this document, therefore, CMC is considered to be a secondary compound, non-essential to the bleaching process, which should necessarily comprise the joint addition of an acrylic acid polymer. Therefore, this document relates to the addition of products to aid the bleaching process, such as oxidation reaction promoters, the results of which are not directly related to the final mechanical properties of the cellulose. Hence, this is a completely different focus from the one proposed in the present application.

Document WO 03/080924 discloses a process for treating pulp including the addition of CMC to the process in which said pulp should contain a calcium concentration exceeding 20 mg/l. Although this document describes a process wherein the addition of CMC is associated with cooking and/or predelignification with oxygen from the pulp, all the teachings therein indicate that the best results are obtained when the additive is introduced in the cooking stage. The high concentration of calcium ions in the pulp aims at favoring the bonds between the fibers and CMC, since both are anionic. In the case of said document, the addition of CMC is associated with the conditions provided by the cooking and delignification liquor, which are highly alkaline.

Document “Advanced wet-end system with carboxymethylcellulose”, Masasuke Watanabe et al, TAPPI JOURNAL, Vol. 3, No. 5, pages 15-19, 2004, discloses studies about a process in which the already processed pulp is treated with the addition of CMC. The purpose of this paper is to use the CMC adsorption on the fibers to increase the efficacy of the chemicals added to the so-called wet end of the approach flow of the paper machine. The results show that the use of CMC in this case allows from 30 to 50% in additive savings. The authors have chosen to follow the results by controlling the electrolytic properties of the pulp and the Degree of Substitution (DS) of the carboxymethylcellulose used. These are important characteristics for assessing the level of surface charges available and CMC binding capacity. The document shows that these results are achieved because of the increase of the anionic surface sites of the pulps treated with CMC. In the case of this article, the lower the degree of substitution of CMC, the better the results, because the paper is directed to using CMC having greater facility to bind to fibers, therefore less negative surface charge. However, it should be noted that these bonds are more fragile by the same reasons, while in the present application stronger bonds are sought.

### SUMMARY OF THE INVENTION

The present invention provides a process for treating cellulose pulp comprising a step of adding carboxymethylcellulose during the acid stage of bleaching said pulp, wherein said carboxymethylcellulose has a degree of substitution (DS) higher than 0.5 and the addition during this stage is made at a pulp pH of less than 5.

The invention further relates to the bleached cellulose pulp obtained according to the process above wherein the mechanical strength properties of cellulose are significantly improved.

### DETAILED DESCRIPTION OF THE INVENTION EMBODIMENTS

As already mentioned, the CMC addition and adsorption on the cellulose fibers during the treatment process of the pulp before being processed in the paper machines, represents a considerable strategic advantage for the cellulose production industry. The procedure increases the mechanical strength properties of cellulose, distinguishing it from the market commodity adding value to the product and meeting the customer expectations.

CMC used in this type of process should preferably have a high molecular weight, because it will be adsorbed on the surface and not inside the cellulose fibers. In general, the viscosity of the CMC used is selected from a range of from 10 to 1500 mPa·s, which is within those available in the market. CMC, as well as fiber cellulose, is anionic but has a higher number of bond groups which, therefore, reinforce the bonds between the fibers. Thus, it is more interesting to have CMC on the surface of the fiber, since it has a high potential of bonds due to the degree of substitution, increasing the binding between the fibers and therefore the paper's mechanical strength. Furthermore, it has a high degree of interaction with water, increasing the WRV (water retention value), which renders it difficult to dry the paper with an increase in the energy consumption to this end and, consequently, the presence of CMC inside the fiber will have only the second effect without contributing to the increase in the paper's strength. Hence, the presence of CMC on the surface of the pulp causes a higher fiber-fiber repulsion, making the interlinking difficult, but once this is overcome, there can be an increase in the contact area between the fibers with the aid of CMC. This increase of the contact area causes a higher number of intermolecular bonds between the cellulose molecules, thus increasing the pulp's mechanical strength. Another advantage of fixing CMC onto the surface is that it causes a greater influence on the volume gain of fibers when compared to the fixing that occurs inside the fibers. This property called Bulk is highly significant in the cellulose market for the production of paper.

During cooking, lyses may occur in the CMC molecules, that is, the molecule is broken into smaller molecules which, instead of being fixed on the fiber surface, are fixed inside, leading to lower paper property gains, and this is one of the drawbacks of adding CMC during cooking.

However, the inventors of the present process have noticed that the addition of CMC during the acid stage of cellulose pulp bleaching, according to the A/D0(EP)DD and A/D0(EP)PP sequences, for example, and under specific conditions, has caused higher mechanical strength gains of the paper than the addition of CMC during the cooking phase mentioned in other prior-art documents. The most significant results have been obtained by adding A/D0 in the acid stage, due to its temperature, pH and retention time conditions, which favor the kinetics of CMC adsorption on the fiber. The CMC adsorption on the fiber during bleaching occurs under strict conditions wherein temperature and pH controls are needed for the adsorption to be efficient. The polymer adsorbs on the fiber both at low and high pH values, but the adsorption in an acid medium occurs more effectively due to the higher availability of binding sites between the fibers and CMC. The temperatures should be considerably high, above 80° C., preferably approximately 95° C., and there should also be a sufficient contact time between the pulp and CMC. This contact time is preferably of at least 40 minutes, most preferably of about 120 minutes.

Another relevant parameter for the good fixation of CMC to the pulp is the degree of substitution (DS) of CMC which, contrary to the temperature, contact time and pH parameters, is a property only of the polymer used and not a variable of the process where the product is applied. The degree of substitution is defined as the ratio of the number of occupied reactive sites to the total number of reactive sites. The inventors have noticed that when a carboxymethylcellulose having a degree of substitution higher than 0.5 is added during the bleaching stage at a pH of less than 5.0, the use of carboxymethylcellulose enables gains in advantageous properties in the treated pulp. The preference expressed in this document is to use CMC with a degree of substitution between 5.6 and 9.6, wherein the properties are more favorable.

The mass of CMC added is not considered to be very large, because, otherwise, there will be a lower fixation of CMC on the cellulose. This happens because, if the mass of CMC added is very large, when there is a trend for the CMC molecules to agglomerate and not be adsorbed onto the fiber, they will form lumps among them. Therefore, the amount of CMC additive used during pulp bleaching should also be determined so as not to product heterogeneity points on the final paper by forming lumps with a loss of properties also in the resulting bleached pulp. Preferably, CMC is added in an amount of from 0.2% to 1%, that is, from 2 to 10 kg per air-dried ton of fiber (kg/adt), depending on the desired property improvement. In these conditions, gains of up to 24% may be obtained in the tensile strength in refined and unrefined pulps having A/D0(EOP)DD sequence, for instance. In these same amounts, in a A/Do(EOP)PP sequence, the tensile strength gains may be of 24% for unrefined pulp and a little more than 8% for refined pulp. The bleaching sequences mentioned are only examples, since CMC is added under acid conditions and similar mechanical property gains are achieved.

It was also noted that the unrefined pulp drainage is not affected, since the refined pulp drainability exhibits a certain drop. Therefore, the Schopper Riegler (°SR) degree increases in both cases, but increases a little bit more for refined pulp. This probably happens due to the CMC capability of adsorbing water, which has already been detected by several authors by determining the water retention value (WRV).

According to a preferred embodiment of the invention, the polymer adsorption on the fiber is favored when there are free cations in the system, because the cations work as bridges between the carbohydrate and the fiber. As fibers and CMC are anionic, the repulsion potential between them may be minimized by the correct addition of these cations to the fibrous suspension. However, it should be noted that this is unnecessary, because once CMC overcomes this repulsion distance, a strong bond is formed with the fiber increasing the desired paper strength. The higher the cation valence, the better CMC will be fixed onto the fiber; however the higher the valence of the cations used, the lower the adsorbed water and the water retention value (WRV) of the fiber, because there is an inverse relationship between the cation valence of the system and the swelling of the fiber. This is also used to reduce the retained water value and, consequently, to decrease the losses in paper drying, which occur with the addition of CMC alone.

In an embodiment of the present invention, CMC added to cellulose protonated with CaCl₂ is used. This salt enables the reduction of the CMC dosage on the fiber resulting in smaller gains in properties than those obtained with the addition of CMC alone. The reduction in the dosed amount of CMC was 40%, which is interesting due to the high cost of this product.

The process of the present invention is useful for the application in the treatment of different cellulose pulps, particularly in eucalyptus wood pulps, such as, for instance, of the species Eucalyptus urophylla, Eucalyptus globulus, Eucalyptus citriodora, Eucalyptus grandis and hybrids thereof.

The process of the present invention will be shown in more details in the examples below.

### EXAMPLE

An eucalyptus pulp sample has been collected from the washing equipment after delignification.

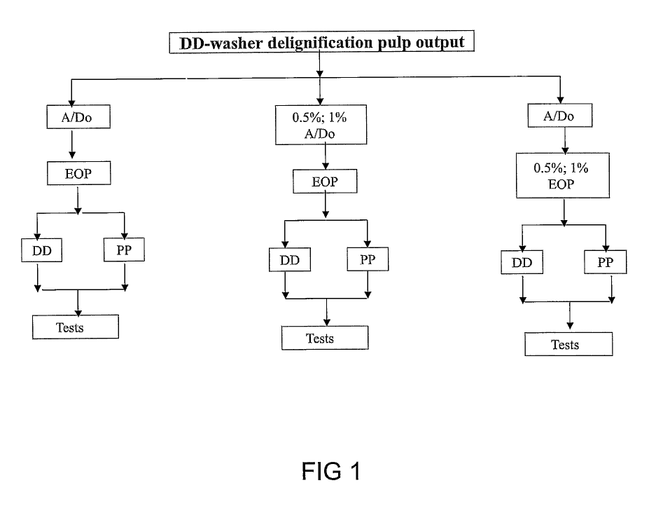

Two bleaching sequences have been simulated, A/D0(EOP)DD and A/Do(EOP)PP, in which 0.5% (5 kg/adt) and 1.0% (10 kg/adt) of CMC were added based on the dry weight of the pulp. The addition was made in the stages A/D0 and EOP to better identify the dosage point, according to the scheme presented in FIG. 1.

The addition of CMC was done in only one stage of each bleaching sequence. Bleaching procedures without additives have also been made to serve as reference. After the bleaching processes, physical and chemical tests were carried out in the pulps.

The load of bleaching reagents used, the temperatures and time in each stage are shown in the table below.

TABLE 1
Bleaching parameters

| | A/D0 | EOP | D | D | P | P |
|---|---|---|---|---|---|---|
| Time (min) | 120 + 15 | 60 | 90 | 90 | 90 | 90 |
| Temperature (° C.) | 95 | 85 | 75 | 75 | 80 | 80 |
| Consistency (%) | 11 | 11 | 11 | 11 | 11 | 11 |
| Load of ClO₂ | 22 | — | 3 | 2 | — | — |
| (kg/adt) | | | | | | |
| Load of HCl | 5 | — | 1 | 2 | — | — |
| (kg/adt) | | | | | | |
| Load of NaOH | — | 10 | — | — | 1 | 0.5 |
| (kg/adt) | | | | | | |
| Load of H₂O₂ | — | 2.5 | — | — | 2 | 1 |
| (kg/adt) | | 5.062 kg/cm² | | | | |
| | | (72 psi) | | | | |

The additive added was CMC Walocel CRT 30G (marketed by Wolff Celulosics) with a degree of substitution ranging from 0.82-0.95 and Brookfield viscosity of 20-40 mPa·s at 25° C. Other CMC samples with degree of substitution within this range have been used with similar results.

The results are presented in graphs in which the value of each property will be shown in the columns, while the percentage gain in relation to the reference value will be shown in the rows.

### Example 1a

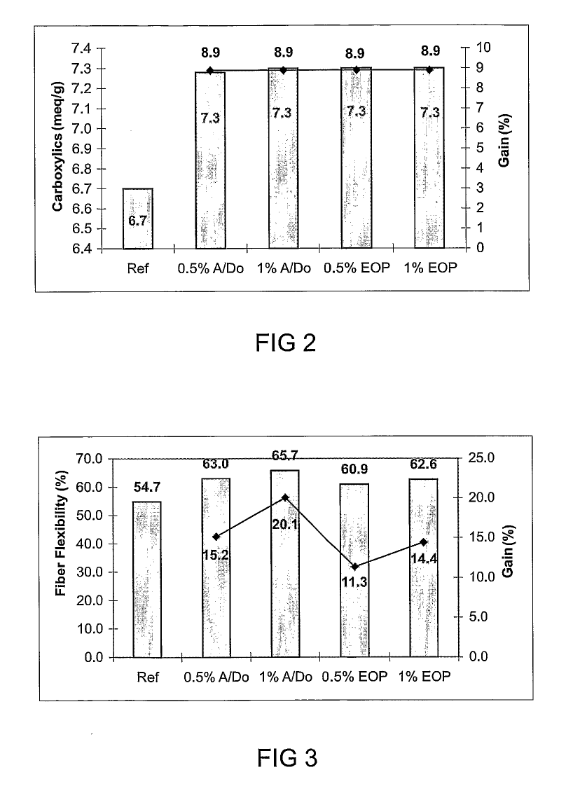

The results for the unrefined pulp sequence A/D0(EOP)DD (0 PFI mill revolution) are shown in FIGS. 2 to 7. FIG. 2 shows the gains in the carboxylic contents of the pulp treated with CMC while FIG. 3 shows the flexibility of the pulp fibers treated with CMC. There has been an increase in the carboxylic content of the fiber corresponding to the higher CMC surface charges and also to an increase in the fiber flexibility due to the effect of plasticity and the CMC binding facility.

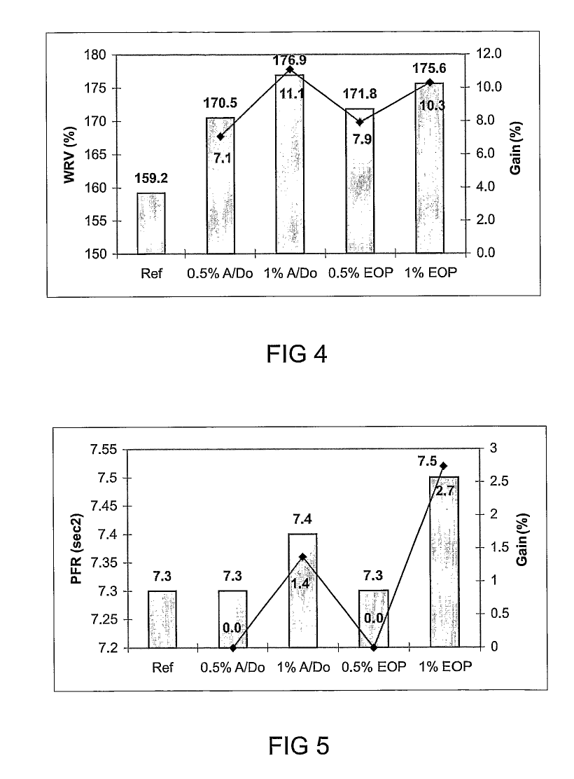

FIGS. 4 and 5 respectively show the water retention values (WRV) in the pulp and the drainage (PFR) of the pulp treated with CMC in the A/D0(EOP)DD bleaching sequence.

Although the pulp treated with CMC in the bleaching stage retains more water, there has been no significant loss in drainage, that is, in terms of process, it would not be necessary to reduce the speed of the drying machine.

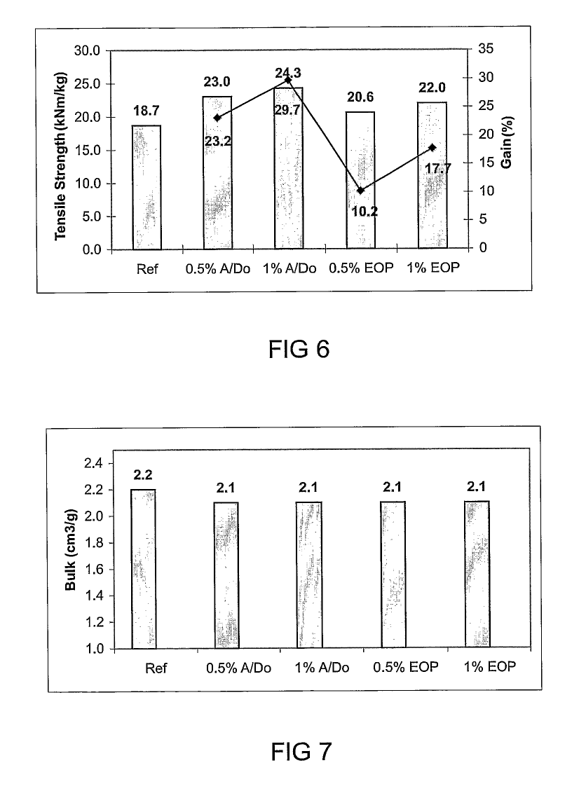

The tensile strength data are shown in FIG. 6 and the bulk value of the treated pulp is depicted in FIG. 7. Bulk is an important property because it represents the volume of a specific mass of cellulose and has an impact on critical properties, such as smoothness, opacity, thickness, basis weight etc.

It has been shown that the addition of CMC during pulp bleaching has generated very significant gains in tensile strength. The gains of the A/D0 stage have been higher due to the conditions of this stage, which presents ideal temperature, reaction time and extremely high pH, favoring the kinetics of CMC adsorption on the fiber. Bulk presents a tendency to drop, however, the reduction found is small and cannot be considered significant.

Other results of the chemical, mechanical and optical properties of the pulp treated with CMC in the bleaching stage following the A/D0(EOP)DD sequence are shown in the table below. The gains presented in the table are in relation to the reference pulp. The table clearly shows that there are also gains in other physical-mechanical properties.

TABLE 2
Results of adding CMC in the A/D0(EOP)DD bleaching sequence, unrefined (0 rev PFI)

| | | 0.5% | | | | 0.5% | | | |
|---|---|---|---|---|---|---|---|---|---|
| Property | Reference | A/Do | Gain (%) | 1% A/Do | Gain (%) | EOP | Gain (%) | 1% EOP | Gain (%) |
| DCAT (meq/l) | 14.0 | 19.3 | 37.9 | 24.3 | 73.6 | 20.0 | 42.9 | 24.3 | 73.6 |
| Zeta Potential | −59.2 | −67.4 | 13.9 | −72.0 | 21.6 | −71.5 | 20.8 | −74.3 | 25.5 |
| (mV) | | | | | | | | | |
| Brightness (% | 91.3 | 91.0 | −0.3 | 90.9 | −0.4 | 91.4 | 0.1 | 91.6 | 0.3 |
| ISO) | | | | | | | | | |
| Brightness | 2.05 | 2.46 | 20.00 | 2.54 | 23.90 | 2.41 | 17.56 | 2.48 | 20.98 |
| Variation (% | | | | | | | | | |
| ISO) | | | | | | | | | |
| Light Disp. Coeff. | 45.72 | 45.56 | 0.53 | 45.12 | −1.31 | 44.48 | −2.71 | 44.74 | −2.14 |
| (m³/KG) | | | | | | | | | |
| a Coordinate (% | −0.42 | −0.44 | 4.76 | −0.42 | 0.00 | −0.33 | −21.43 | −0.15 | −64.29 |
| ISO) | | | | | | | | | |
| b Coordinate (% | 2.97 | 2.94 | −1.01 | 2.94 | −1.01 | 3.03 | 2.02 | 2.99 | 0.67 |
| ISO) | | | | | | | | | |
| Instron Tension | 331.7 | 373.4 | 12.6 | 396.1 | 19.4 | 358.8 | 8.2 | 385.3 | 16.2 |
| (g/in) | | | | | | | | | |
| Tear Index | 3.75 | 4.28 | 14.13 | 4.28 | 14.13 | 4.50 | 20.00 | 4.07 | 8.53 |
| (Nm^{2/}Kg) | | | | | | | | | |
| Air Resistance | 1.27 | 1.35 | 6.30 | 1.43 | 12.60 | 1.30 | 2.36 | 1.33 | 4.72 |
| (s/100 ml) | | | | | | | | | |
| Tensile Stiffness | 2.92 | 3.42 | 17.12 | 3.59 | 22.95 | 3.28 | 12.33 | 3.29 | 12.67 |
| (MN/kg) | | | | | | | | | |
| TEA Index | 0.36 | 0.51 | 41.67 | 0.54 | 50.00 | 0.37 | 2.78 | 0.33 | −8.33 |
| (Kj/Kg) | | | | | | | | | |
| Schopper | 18.0 | 19.5 | 8.3 | 20.5 | 13.9 | 19.0 | 5.6 | 19.0 | 5.6 |
| Riegler | | | | | | | | | |
| (°SR) | | | | | | | | | |
| Breaking | 1.91 | 2.35 | 23.04 | 2.47 | 29.32 | 2.05 | 7.33 | 2.08 | 8.90 |
| Length | | | | | | | | | |
| (Km) | | | | | | | | | |
| Elongation (%) | 2.42 | 2.78 | 14.88 | 2.88 | 19.01 | 2.29 | −5.37 | 2.11 | −12.81 |

### Example 1b

### A/D0(EOP)DD Sequence—3000 rev PFI (Refined Pulp in PFI Mill Up to 3000 Revolutions/Minute)

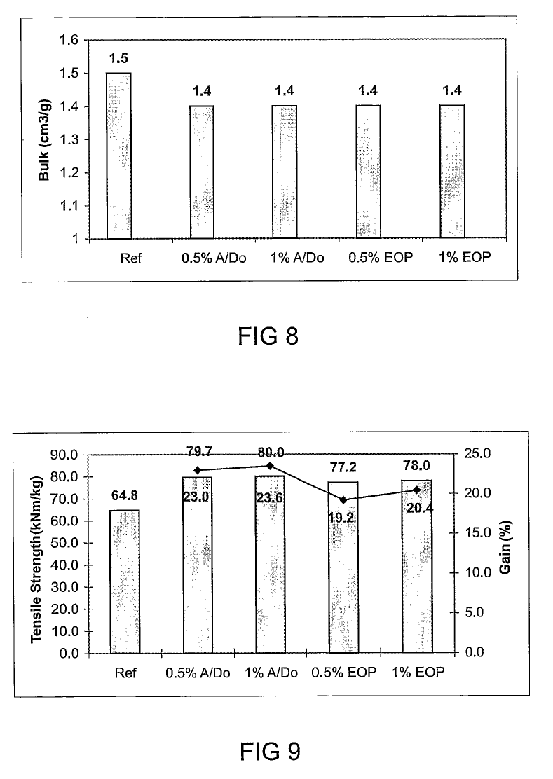

The tensile strength and bulk data for the pulp obtained with the A/D0(EOP)DD sequence after refining are shown in FIGS. 8 and 9.

The gains in tensile strength for the refined pulp were also very significant. Once again, the gains in the A/D0 stage have been shown to be higher than the gains of the addition in the EOP stage. Bulk maintains its drop trend, but the drop was once again not very significant.

In the refined pulp there was a drop in drainability after the addition of CMC. With the fibrillation obtained in refining, more carboxylic groups emerge on the surface of the fiber. These new groups added to the CMC groupings generate a higher number of hydrogen bridge bonds between the fiber and the water, consequently causing a loss in drainage.

In the refined pulp, there has been an high increase in air resistance, that is, the pulp became less porous. For papers that do not need high porosity (PW), this gain can be very interesting.

Other results for the refined pulp are shown in Table 3 below:

TABLE 3

| Property | Reference | 0.5% A/Do | Gain (%) | 1% A/Do | Gain (%) | 0.5% EOP | Gain (%) | 1% EOP | Gain (%) |
|---|---|---|---|---|---|---|---|---|---|
| Light Disp. | 31.10 | 29.45 | −5.31 | 29.83 | −4.08 | 29.49 | −5.18 | 29.38 | −5.53 |
| Coeff. | | | | | | | | | |
| (m³/kg) | | | | | | | | | |
| Tear Index | 9.06 | 10.20 | 12.58 | 8.62 | −4.86 | 9.26 | 2.21 | 8.86 | −2.21 |
| (Nm²/kg) | | | | | | | | | |
| Air Resistance | 17.40 | 33.40 | 91.95 | 40.20 | 131.03 | 35.10 | 101.72 | 41.40 | 137.93 |
| (s/100 ml) | | | | | | | | | |
| Tensile Stiffness | 6.62 | 7.33 | 10.73 | 7.30 | 10.27 | 7.04 | 6.34 | 6.98 | 5.44 |
| (MN/kg) | | | | | | | | | |
| TEA Index | 2.18 | 2.63 | 20.64 | 2.76 | 26.61 | 2.87 | 31.65 | 2.87 | 31.65 |
| (kJ/kg) | | | | | | | | | |
| Breaking Length | 6.60 | 8.07 | 22.27 | 8.16 | 23.64 | 7.88 | 19.39 | 7.91 | 19.85 |
| (km) | | | | | | | | | |
| Elongation | 4.78 | 4.88 | 2.09 | 5.10 | 6.69 | 5.43 | 13.60 | 5.39 | 12.76 |
| (%) | | | | | | | | | |

### Example 2a

### A/D0(EOP)PP Sequence—Unrefined (0 rev PFI)

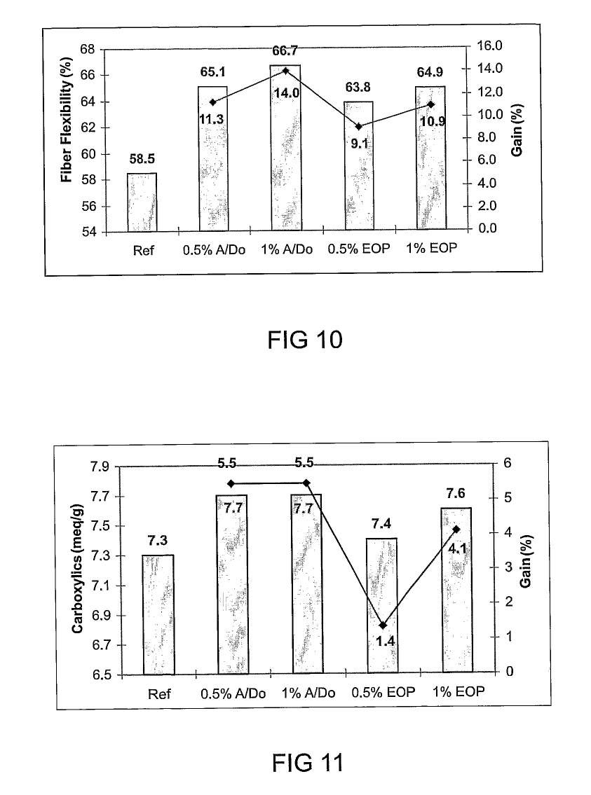

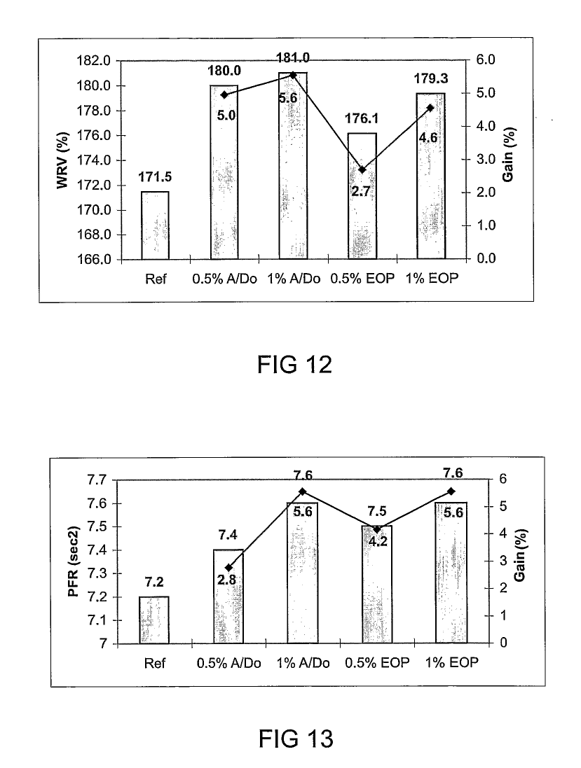

In the sequences with final PP bleaching stages, another sequence has been used and there has been an increase in the content of carboxylics and in the flexibility of fibers with the addition of CMC, as shown in FIGS. 10 and 11. A higher water retention has also been noted in the pulp treated with CMC, however, the loss of drainability is not so significant as to need a large reduction in the speed of the drying machine (FIGS. 12 and 13).

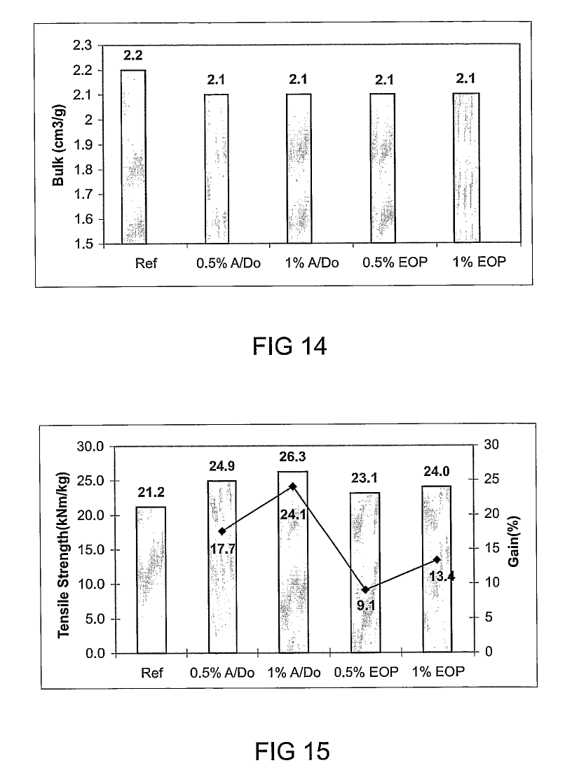

As in the A/D₀(EOP)DD bleaching sequence, the gains in tensile strength were very significant (FIG. 14). Once again, the largest gains occurred in the pulp in which the addition of the polymer was made in the A/D₀ stage due to the conditions of this stage. Bulk (FIG. 15) maintains its drop trend, but the drop is also not significant, as in all other cases. Other results are shown in Table 4 below.

TABLE 4

| Property | Reference | 0.5% A/Do | Gain (%) | 1% A/Do | Gain (%) | 0.5% EOP | Gain (%) | 1% EOP | Gain (%) |
|---|---|---|---|---|---|---|---|---|---|
| DCAT | 20.3 | 25.3 | 24.6 | 31.0 | 52.7 | 27.0 | 33.0 | 27.7 | 36.5 |
| (meq/l) | | | | | | | | | |
| Zeta Potential | −66.6 | −69.0 | 3.6 | −71.2 | 6.9 | −54.3 | −18.5 | −64.6 | −3.0 |
| (mV) | | | | | | | | | |
| Brightness | 89.0 | 88.6 | −0.4 | 86.6 | −2.7 | 87.2 | −2.0 | 87.9 | −1.2 |
| (% ISO) | | | | | | | | | |
| Brightness Variation | 1.77 | 1.72 | −2.82 | 1.83 | 3.39 | 1.85 | 4.52 | 1.85 | 4.52 |
| (% ISO) | | | | | | | | | |
| Light Disp. Coeff. | 46.22 | 45.04 | −2.55 | 44.94 | −2.77 | 44.24 | −4.28 | 44.34 | −4.07 |
| (m³/kg) | | | | | | | | | |
| a Coordinate | −0.34 | −0.37 | 8.82 | −0.30 | −11.76 | −0.19 | −44.12 | −0.26 | −23.53 |
| (% ISO) | | | | | | | | | |
| b Coordinate | 3.88 | 3.96 | 2.06 | 4.78 | 23.20 | 4.71 | 21.39 | 4.61 | 18.81 |
| (% ISO) | | | | | | | | | |
| Instron Tension | 350.3 | 418.0 | 19.3 | 468.6 | 33.8 | 398.0 | 13.6 | 393.2 | 12.2 |
| (g/in) | | | | | | | | | |
| Tear Index | 4.47 | 5.46 | 22.15 | 5.61 | 25.50 | 5.21 | 16.55 | 4.43 | −0.89 |
| (Nm²/kg) | | | | | | | | | |
| Air Resistance | 1.27 | 1.47 | 15.75 | 1.54 | 21.26 | 1.31 | 3.15 | 1.31 | 3.15 |
| (s/100 ml) | | | | | | | | | |
| Tensile Stiffness | 3.17 | 3.67 | 15.77 | 3.67 | 15.77 | 3.56 | 12.30 | 3.51 | 10.73 |
| (MN/kg) | | | | | | | | | |
| TEA Index | 0.44 | 0.56 | 27.27 | 0.65 | 47.73 | 0.48 | 9.09 | 0.48 | 9.09 |
| (kJ/kg) | | | | | | | | | |
| Schopper Riegler | 19.5 | 21.0 | 7.7 | 22.0 | 12.8 | 20.0 | 2.6 | 20.0 | 2.6 |
| (°SR) | | | | | | | | | |
| Breaking Length | 2.16 | 2.54 | 17.59 | 2.68 | 24.07 | 2.36 | 9.26 | 2.31 | 6.94 |
| (km) | | | | | | | | | |
| Elongation | 2.61 | 2.92 | 11.88 | 3.19 | 22.22 | 2.71 | 3.83 | 2.62 | 0.38 |
| (%) | | | | | | | | | |

### Example 2b

### A/D₀(EOP)PP Sequence Refined at 3000 rev PFI

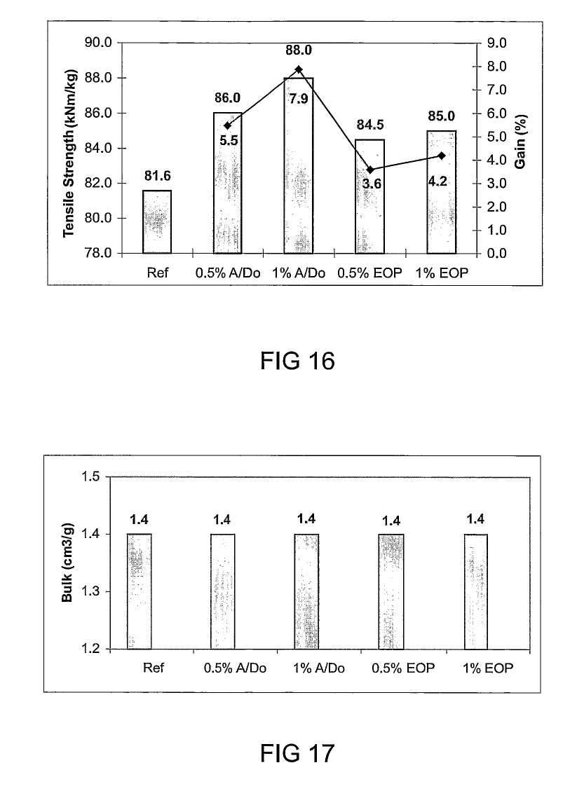

For the pulp bleached in the A/D₀(EOP)PP sequence, refined and treated with CMC according to the present invention, the A/D₀ stage has also shown higher gains in the tensile strength and bulk has not varied as can be evidence by the data shown in FIGS. 16 and 17.

The tensile strength results of the final bleaching sequences with PP show values that are higher than those of the sequences with final DD bleaching stages due to the swelling that occurs in the fibers in the last bleaching stages (alkaline swelling).

Other significant results are shown in Table 5 below.

TABLE 5

| Property | Reference | 0.5% A/Do | Gain (%) | 1% A/Do | Gain (%) | 0.5% EOP | Gain (%) | 1% EOP | Gain (%) |
|---|---|---|---|---|---|---|---|---|---|
| Light Disp. Coeff. | 29.32 | 28.44 | −3.00 | 27.23 | −7.13 | 27.50 | −6.21 | 27.35 | −6.72 |
| (m³/kg) | | | | | | | | | |
| Tear Index | 9.51 | 10.50 | 10.41 | 8.68 | −8.73 | 8.85 | −6.94 | 8.58 | −9.78 |
| (Nm²/kg) | | | | | | | | | |
| Air Resistance | 49.70 | 64.20 | 29.18 | 88.90 | 78.87 | 71.80 | 44.47 | 86.90 | 74.85 |
| (s/100 ml) | | | | | | | | | |
| Tensile Stiffness | 7.30 | 7.48 | 2.47 | 7.32 | 0.27 | 7.20 | −1.37 | 7.36 | 0.82 |
| (MN/kg) | | | | | | | | | |
| TEA Index | 2.90 | 3.03 | 4.48 | 3.09 | 6.55 | 3.20 | 10.34 | 3.10 | 6.90 |
| (kJ/kg) | | | | | | | | | |
| Breaking Length | 8.32 | 8.77 | 5.41 | 8.62 | 3.61 | 8.62 | 3.61 | 8.57 | 3.00 |
| (km) | | | | | | | | | |
| Elongation | 5.25 | 5.24 | −0.19 | 5.42 | 3.24 | 5.62 | 7.05 | 5.46 | 4.00 |
| (%) | | | | | | | | | |

Therefore, it has been concluded that the addition of CMC during bleaching generates relevant gains in pulp quality. The bleaching stage with the most significant gains was the A/D₀ stage, due to its temperature, pH and retention time conditions, which favor the kinetics of CMC adsorption on the fiber.

### Example 3

Results obtained with the application of CMC and protonization of cellulose with CaCl₂. In this case, an eucalyptus pulp collected before the bleaching process has been used, similar to the one used in example 1 and the CMC used was CMC 39798 produced by Noviant, with the following properties: DS 0.57 viscosity 285 mPa·s. The CMC used in this case has a degree of substitution of 0.57, a little lower than the degree of substitution used in the previous examples, but the results were similar.

Three different analyses have been made and applied to the bleaching steps using CMC and cellulose protonization in a ADoPoPP sequence. The first one used a dosage of 0.5% of CMC applied in two different points, Do and Po within the ADoPoPP sequence.

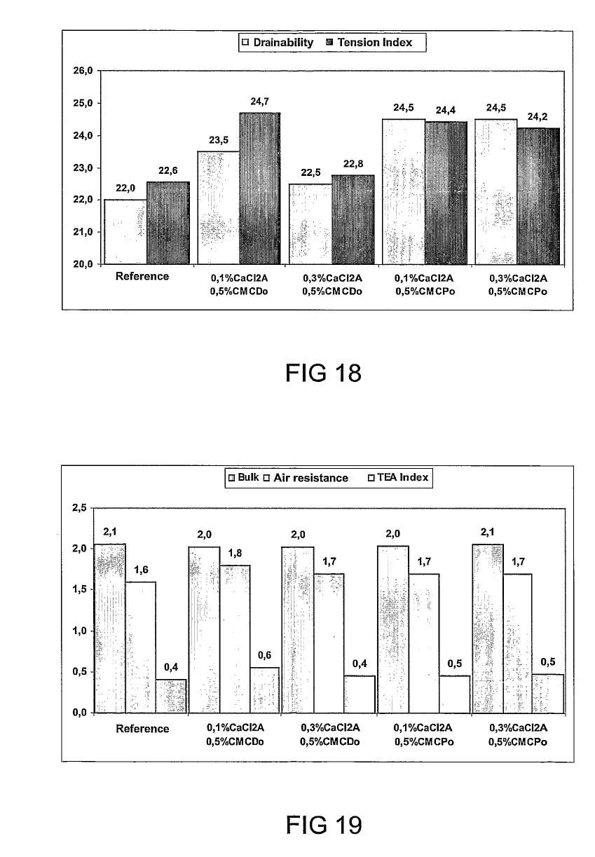

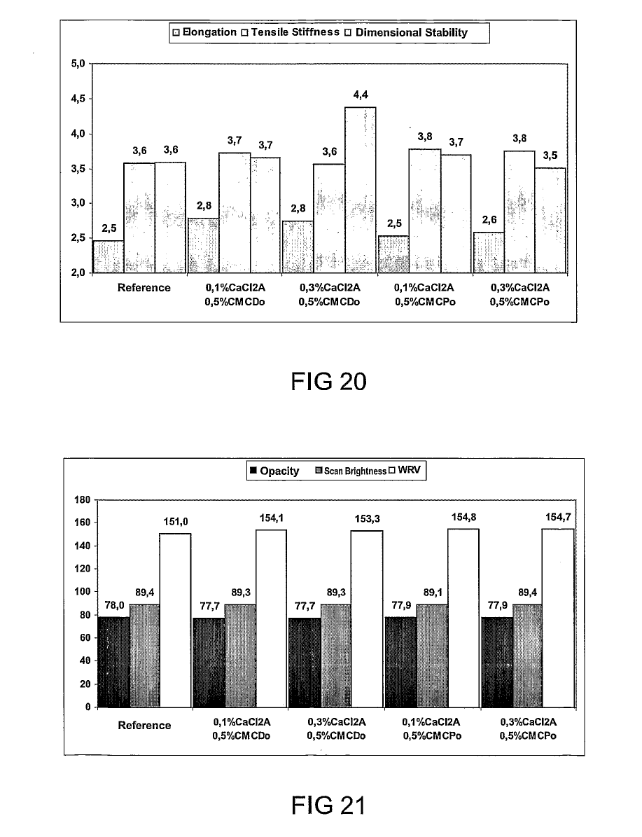

Another dosage of 0.1% and 0.3% of CaCl₂ has also been used for each variation in the application of CMC. The results are shown in FIGS. 18 and 21 and can be summarized as follows:

The graph in FIG. 18 comparing the tension and drainability values wherein the best dosage of CMC has been fixed at 0.5%, and varying the dosage point and also the protonization level, shows a similar variation between the tension index and °SR.

The highest increase in the tension index was of 9.3% with the CMC dosage in the D₀ stage and the lowest dosage of CaCl₂ (0.1%) before entering this bleaching stage, when compared with CMC dosages at Po or dosages of 0.3% CaCl₂ in the same point than the previous one.

The SR in these same conditions increases in 22.0%, which is not vary far from the reference that reached a maximum value of 24.5%.

No variations were detected in the bulk or the air permeability resistance in these experimental conditions.

Curiously, the hygroexpansivity, tensile stiffness, opacity, brightness and WRV have also varied little in the conditions presented.

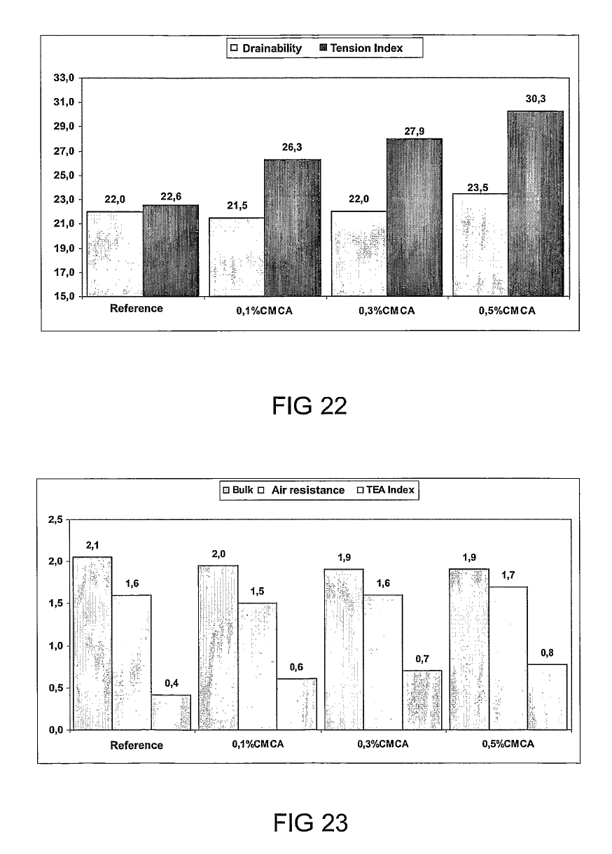

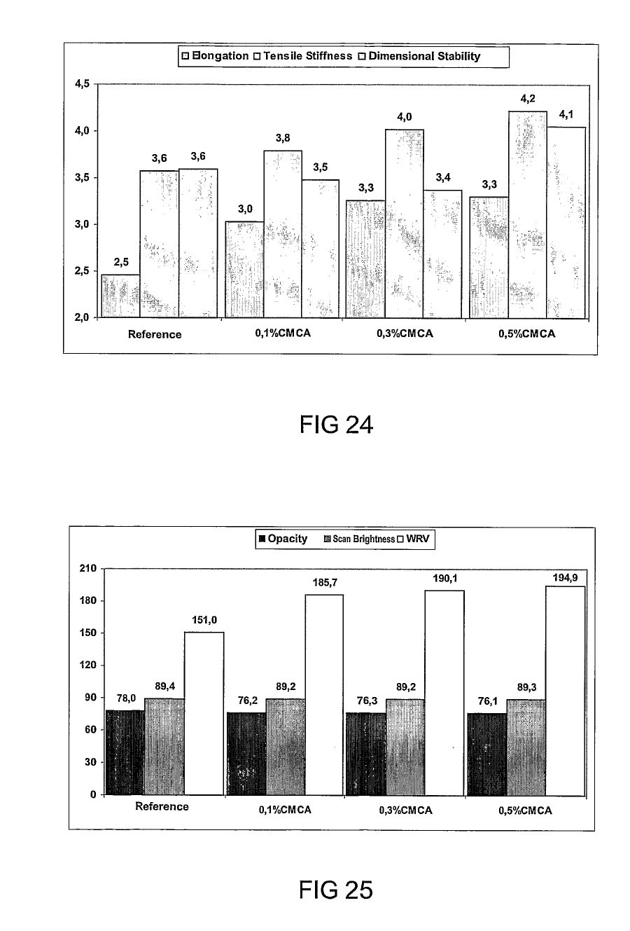

A second analysis was made only with dosages of CMC in the acid stage in the amounts of 0.1%, 0.3% and 0.5%. The results are shown in FIGS. 22 to 25 and are the following:

°SR (Schopper Riegler drainability) only increased 1.5 in the case of the 0.5% dosage.

Tension has progressively increased in 16.4% for the addition of 0.1% of CMC, 23.5% for the addition of 0.3% of CMC and 34.1% for the addition of 0.5% of CMC.

In these conditions, bulk decreases 0.15 cm³/g at most, TEA (Tensile Energy Absorption) progressively increases in 46% for 0.1% of CMC, 70.7% for 0.3% of CMC and 87.8% for 0.5% of CMC, and the air permeability resistance is unchanged.

The maximum increase in elongation of 32% occurs up to the dosage of 0.3% of CMC and is kept constant at the dose of 0.5%.

Curiously, the hygroexpansivity slightly decreases at 0.1% and 0.3%, but increases 12.8% when 0.5% of CMC is dosed.

The tensile stiffness property also progressively increases 6.2% for a dosage of 0.1% of CMC, increases 12.6% for a dosage of 0.3% of CMC and increases 18.2% for a dosage of 0.5% of CMC.

The opacity decreases 1.8% at most in these conditions, brightness remains constant and WRV has a maximum increase of 23% with a dosage of 0.1%, understandable because of the characteristics of the CMC used.

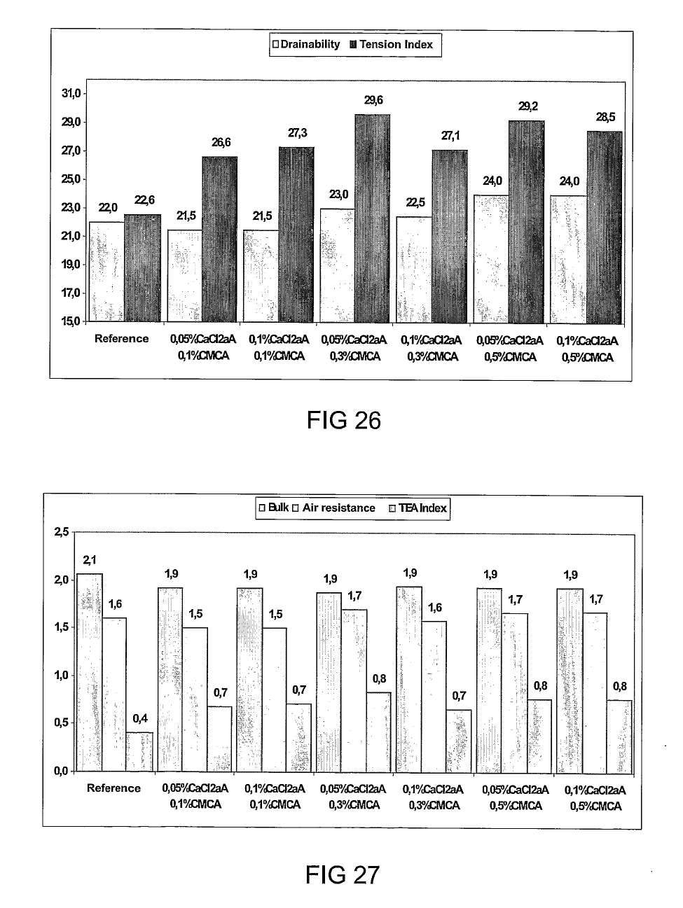

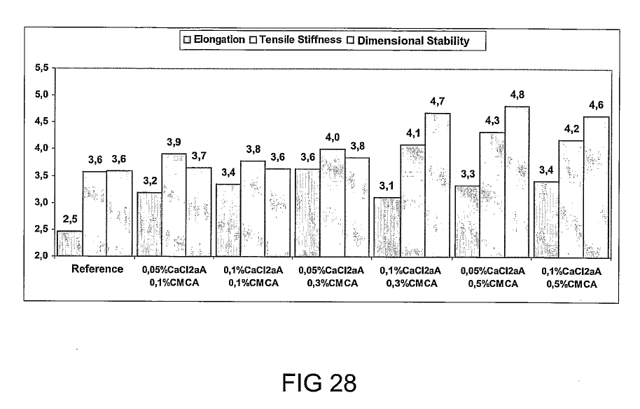

In a third experimental analysis, the dosage of CMC was only in the acid stage in the amounts of 0.1%, 0.3%, 0.5% and dosages of 0.05% and 0.1% of CaCl₂ before the acid stage. The results are represented in FIGS. 26 to 28:

In °SR, there is a slight reduction with 0.1% of CMC and a slight increase with 0.5% of CMC; in both cases, the dosage of CaCl₂ was irrelevant for the property obtained.

The highest increase in the tension index was of 31% with the dosage of 0.3% of CMC in the acid stage and 0.05% of CaCl₂ before the acid stage, but there is also an increase of 29.2% with the dosage of 0.5% of CMS in the acid stage and 0.05% of CaCl₂ before the acid stage.

The bulk and air permeability resistance have remained almost unchanged with the dosages applied.

TEA (Tensile Energy Absorption) has increased significantly with a highest increase of 102% with dosages of 0.3% of CMC in the acid stage and 0.05% of CaCl₂ before the acid stage. However, the lowest increase obtained was 65.9% for a dosage of 0.1% of CMC in the acid stage and 0.05% of CaCl₂ before the acid stage.

The increase in elongation is similar to the increase in TEA, and the highest increase obtained in this property was 44% for a dosage of 0.3% of CMC in the acid stage and 0.05% of CaCl₂ before the acid stage.

The highest increase in the tensile stiffness was of 21% for the highest dosage employed of CMC in the acid stage and the lowest dose of CaCl₂ before the acid stage.

The hygroexpansivity increased significantly with an increase in the dosage of CMC or when the average dose of CMC was combined with 0.1% of CaCl₂, which probably preserves CMC on the surface of the fiber. As already mentioned, this behavior is expected because of the characteristics of CMC.

The opacity decreases from 1% to 2% depending on the case, while brightness remains virtually constant.

WRV increases according to the CMC dosage, regardless of CaCl₂, increasing up to 27.6% in the most critical case.

According to the analyses performed, the comparisons confirm that the best dosage point of CMC for the desired purposes is the bleaching acid stage. The gains when compared with the other tested stages are significant.

As to the protonization option of fibers, relevant results have also been obtained showing that it is possible to optimize the dosage of CMC with the combination of calcium chloride. Although the gains in stress are slightly lower, the addition of this salt before the acid stage enables savings of 40% on the dosage of CMC, which is significant due to the high cost of this input.

1. A process for treating cellulose pulp, characterized by comprising a step of adding carboxymethylcellulose during the acid stage of bleaching said pulp, wherein said carboxymethylcellulose has a degree of substitution (DS) higher than 0.5 and the addition during the acid stage is carried out a pulp pH of less than 5.

2. A process according to claim 1, characterized by comprising the A/DO(EP)DD or A/DO(EP)PP sequence.

3. A process according to claim 1, characterized in that
carboxymethylcellulose is added in an amount of from 2 kg/adt to 10 kg/adt.

4. A process according to claim 1, characterized in that said degree of substitution varies from 0.56 to 0.96.

5. A process according to claim 2, characterized in that the addition of CMC is carried out in the A/Dₒ stage.

6. A process according to claim 5, characterized in that the addition of CMC in the A/Do stage is made at a temperature above 80° C. with a contact time between CMC and the pulp of at least 40 minutes.

7. A process according to claim 6, characterized in that the temperature is approximately 95° C. and the contact time is approximately 120 minutes.

8. A cellulose pulp characterized by being treated by a bleaching process such as defined in claim 1.

9. A cellulose pulp characterized by being treated by a bleaching process such as defined in claim 2.

10. A cellulose pulp characterized by being treated by a bleaching process such as defined in claim 3.

11. A cellulose pulp characterized by being treated by a bleaching process such as defined in claim 4.

12. A cellulose pulp characterized by being treated by a bleaching process such as defined in claim 5.

13. A cellulose pulp characterized by being treated by a bleaching process such as defined in claim 6.

14. A cellulose pulp characterized by being treated by a bleaching process such as defined in claim 7.
